(19) United States
(12) Patent Application Publication
(10) Pub. No.: US 2006/0224900 A1
(43) Pub. Date: Oct. 5, 2006

(54) Data processing apparatus and personal authentication apparatus

(75) Inventors: Keisuke Watanabe, Mizuho-City (JP); Tatsushi Ohyama, Ogaki-City (JP); Hirofumi Saitoh, Ogaki-City (JP); Masaya Okumura, Yoro-gun (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/392,579

(22) Filed: Mar. 30, 2006

(30) Foreign Application Priority Data
Mar. 30, 2005 (JP) 2005-097002

(51) Int. Cl. H04K 1/00

(52) U.S. Cl. 713/186

(57) ABSTRACT

A data holding unit holds data sets each composed of a fingerprint image and recording setting data associated with the fingerprint image. A fingerprint image acquisition unit acquires a fingerprint image newly from a user. A similarity value calculation unit compares the fingerprint image newly acquired from the user and the fingerprint image held in the data holding unit, and indicates a degree of similarity therebetween as a similarity value by using a similarity evaluation function for indicating a degree of similarity between a plurality of types of fingerprint images. A load data selection unit reads recording setting data corresponding to a fingerprint image having a similarity value reaching or exceeding a predetermined value if the fingerprint image is held in the data holding unit, and reads certain data prepared in advance if not.

### BACKGROUND OF THE INVENTION

1. Field of the Invention

The invention relates to a technology for authenticating individuals by using biometric information.

2. Description of the Related Art

Technologies for authenticating individuals by using biometric information are now becoming prevalent. These technologies require that the biometric information on the individuals be registered in advance. For example, in fingerprint authentication technology, users' fingerprints are initially registered before the users are authenticated through fingerprint verification. Japanese Patent Laid-Open Publication No. 2001-45580 discloses a technology in which fingerprint images of users are registered into a remote controller of AV equipment or the like in advance. When using the AV equipment or the like, the characteristic portions of the registered images and that of a fingerprint image that is input to a sensor of the remote controller are collated to identify the user and read settings corresponding to the user. Moreover, Japanese Patent Laid-Open Publication No. 2005-6259 discloses a technology in which fingerprint patterns are registered into a document processing apparatus in advance. When using the document processing apparatus, the registered images and a fingerprint pattern that is acquired by a sensor arranged on an operation panel of that apparatus are collated to identify the user and read settings corresponding to the user.

For example, apparatuses to be shared by a plurality of persons, such as a copying machine, are desirably given settings associated with the preferences of the respective users. For the purpose of such settings, users' biometric information may be used to identify the users. Depending on the methods, conditions, and other factors of the acquisition of the biometric information, however, it is not always possible to acquire exactly the same biometric information from an identical user. In such cases, users who are supposed to be authenticated might possibly fail in authentication. Besides, the operation for registering biometric information is typically troublesome to users.

### SUMMARY OF THE INVENTION

The present invention has been achieved in view of the foregoing circumstances. It is thus an object of the present invention to take advantage of the personal authentication while maintaining simple operability.

One of the aspects of the present invention relates to a data processing apparatus. This data processing apparatus comprises: a data holding unit which holds a data set composed of biometric data and associated data associated with the biometric data; a biometric data acquisition unit which acquires biometric data newly from a user; a similarity evaluation unit which compares the biometric data newly acquired from the user and the biometric data held in the data holding unit, and indicates a degree of similarity therebetween as a similarity value by using a similarity evaluation function for indicating a degree of similarity between a plurality of types of biometric data; and a load data selection unit which reads associated data corresponding to biometric data having a similarity value reaching or exceeding a predetermined value if the biometric data having the similarity value reaching or exceeding the predetermined value is held in the data holding unit, and reading certain data prepared in advance if not.

This data processing apparatus reads the associated data corresponding to biometric data when the biometric data acquired from the user and the biometric data held in the data holding unit are similar to each other, and reads certain data prepared in advance if they are not similar. Since either the associated data or the certain data is thus read out, the user can continue operation by using the read data regardless of whether the user is authenticated successfully or not.

Another aspect of the present invention relates to a personal authentication apparatus. This personal authentication apparatus comprises: an operation unit capable of detecting a plurality of types of operations made by a user; and a biometric data acquisition unit which acquires biometric data from a sensor arranged in an area where the user makes contact. According to this personal authentication apparatus, the biometric data of the user can be acquired simultaneously with user operations. The user thus need not be aware of the input of the biometric data explicitly.

Incidentally, any combinations of the foregoing components, and any conversions of expressions of the present invention from/into methods, apparatuses, systems, computer programs, recording media, and the like are also intended to constitute applicable aspects of the present invention.

### BRIEF DESCRIPTION OF THE DRAWINGS

FIG. 1 is a functional block diagram of a data processing apparatus according to an embodiment;

FIG. 2 is a diagram showing a plurality of data sets according to the embodiment;

FIG. 3 is a flowchart for outlining the processing steps of the data processing apparatus according to the embodiment;

FIG. 4 is a flowchart for showing the process of reading recording setting data according to the embodiment;

FIG. 5 is a flowchart for showing the process of updating the recording setting data according to the embodiment;

FIG. 6 is a flowchart for showing the process of integrating data sets according to the embodiment;

FIG. 7 is a diagram for explaining how to operate a hard disk recorder and how to acquire a fingerprint image according to the embodiment;

FIG. 8 is a flowchart pertaining to user authentication according to the embodiment; and

FIG. 9 is a diagram showing a joystick according to a modification of the embodiment.

### DETAILED DESCRIPTION OF THE INVENTION

The present embodiment will deal with an example where the data processing apparatus and the personal authentication apparatus according to the present invention are applied to a hard disk recorder. This hard disk recorder can be operated in accordance with finger motions on a sensor which is formed on its operation unit. This sensor acquires fingerprint images during operation as biometric information for authenticating users. This hard disk recorder holds data for reflecting preferences of the users, in association with the fingerprint images. Here, the preferences of the users to be reflected include recorded programs and the numbers of times of recording. If a fingerprint image acquired from a user during operation is similar to one of the fingerprint images held in the hard disk recorder, the data corresponding to that similar fingerprint image is read out. The hard disk recorder displays the program names included in that data.

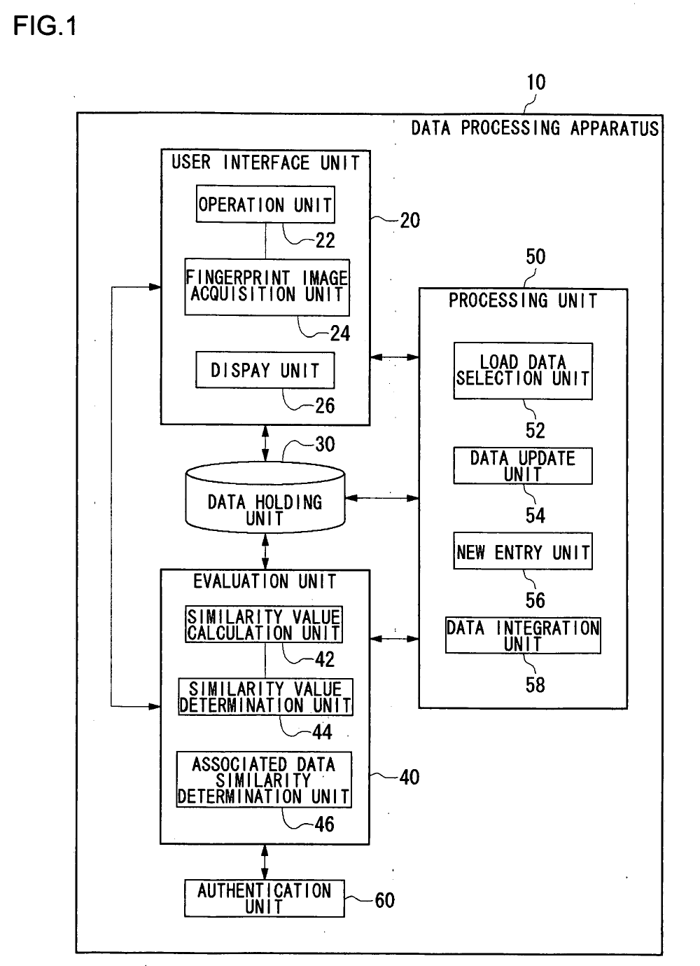

FIG. 1 is a functional block diagram of the data processing apparatus according to the present embodiment. In terms of hardware, the individual blocks shown here can be achieved by various types of elements such as a processor and a RAM, as well as various types of devices such as a sensor. In terms of software, they can be achieved by a computer program and the like. Here, the shown functional blocks are achieved by cooperation thereof. It will therefore be understood by those skilled in the art that these functional blocks can be realized in various forms depending on the combination of hardware and software.

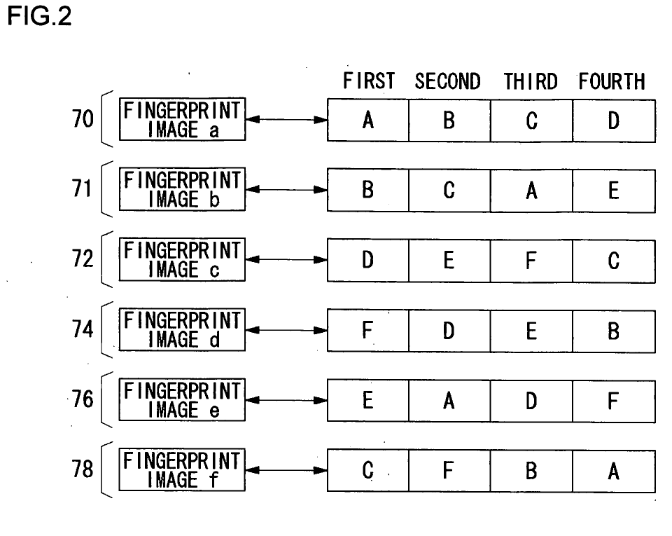

The data processing apparatus 10 includes a user interface unit 20, a data holding unit 30, an evaluation unit 40, a processing unit 50, and an authentication unit 60. The user interface unit 20 acquires fingerprint images of users. The data holding unit 30 holds the fingerprint images acquired by the user interface unit 20 and data pertaining to the users' inclinations as to recording of the hard disk recorder (also referred to as “recording setting data”) in association with each other. Hereinafter, a set of an acquired fingerprint image and recording setting data associated with the image will also be referred to as a “data set.” The recording setting data is data on the programs recorded by the users in the past and the numbers of times of recording of the respective programs. The recording setting data will be detailed further with reference to FIG. 2. The evaluation unit 40 calculates a degree of similarity between fingerprint images as a similarity value, and determines if the fingerprint images are similar enough to be regarded as matching. The evaluation unit 40 also determines if a plurality of types of recording setting data held in the data holding unit 30 are similar to each other. Depending on the determinations made by the evaluation unit 40, the processing unit 50 reads recording setting data from the data holding unit 30. The processing unit 50 also updates the recording setting data in the data holding unit 30 in accordance with tendency of recording by the user. The authentication unit 60 authenticates users when the evaluation units 40 determines that fingerprint images are similar.

The user interface unit 20 includes an operation unit 22, a fingerprint image acquisition unit 24, and a display unit 26. The operation unit 22 accepts finger operations made by a user, and detects the motion of the finger. The hard disk recorder is operated based on the finger motion. The fingerprint image acquisition unit 24 acquires a fingerprint image on condition that the finger motion makes a predetermined movement during operation. The processing as to the acquisition of the fingerprint image will be detailed later. The display unit 26 displays programs included in recording setting data when the processing unit 50 reads the recording setting data from the data holding unit 30.

The evaluation unit 40 includes a similarity value calculation unit 52, a similarity value determination unit 44, and an associated data similarity determination unit 46. The similarity value calculation unit 42 calculates a degree of similarity or a similarity value between a fingerprint image newly acquired from a user (also referred to as “acquired image”) and a fingerprint image held in the data holding unit 30 (also referred to as “held image”) by using pattern matching, for example. The similarity value determination unit 44 determines that the fingerprint images are similar if the similarity value calculated by the similarity value calculation unit 42 reaches or exceeds a predetermined value, and that they are not similar if not. The associated data similarity determination unit 46 determines if a plurality of types of recording setting data held in the data holding unit 30 are similar to each other. As employed herein, the terms “acquired image” and “held image” are used in order to make a clear distinction between a newly-acquired fingerprint image and a fingerprint image held in the data holding unit 30 in particular.

The processing unit 50 includes a load data selection unit 52, a data update unit 54, a new entry unit 56, and a data integration unit 58. The load data selection unit 52 reads the recording setting data corresponding to a held image when the similarity value determination unit 44 determines that the acquired image and the held image are similar. When a user makes a new recording setting different from the recording setting corresponding to the read recording setting data, the data update unit 54 updates the read recording setting data in accordance with the new recording setting. The new entry unit 56 writes a new data set into the data holding unit 30 when the data holding unit 30 holds no fingerprint image similar to the acquired image of the user. The new data set consists of the acquired image and the recording setting data corresponding to the recording setting made by the user. The data integration unit 58 integrates a plurality of data sets held in the data holding unit 30 if the similarity value determination unit 44 determines that the held images included in the plurality of data sets are similar to each other and the associated data similarity determination unit 46 determines that the pieces of recording setting data corresponding to those held images are similar to each other.

FIG. 2 is a diagram showing a plurality of data sets. The data holding unit 30 holds a held image and a piece of recording setting data corresponding to the held image as each single data set. For example, as shown in the diagram, the data holding unit 30 holds fingerprint images a, b, c, d, e, and f, and pieces of recording setting data associated with the fingerprint images as respective data sets 70, 71, 72, 74, 76, and 78. The recording setting data contains the program names of programs that users have recorded by using the hard disk recorder, and the numbers of times the respective programs have been recorded by the users (also referred to as “the numbers of times of recording”). The program names are arranged in descending order of the number of times of recording. For example, as shown in FIG. 2, the recording setting data included in the data set 70 contains the program names of programs A, B, C, and D. In this case, the number of times of recording by the user descends in order of the programs A, B, C, and D. For convenience of explanation, FIG. 2 shows an example where the number of programs included in each piece of recording setting data is four, whereas it actually is not limited to four. Moreover, while the present embodiment deals with the case where the recording setting data contains program names, it may also include other data. Examples include G codes (TM) or coded items intended for timer recording of TV programs such as a recording date and time and a recording channel, as well as data for identifying programs such as the name of a TV station and a broadcasting date and time.

Description will now be given of how to read recording setting data. The similarity value determination unit 44 determines whether or not an acquired image is similar to the fingerprint images a, b, c, d, e, and f. The load data selection unit 52 reads the recording setting data corresponding to a fingerprint image that the similarity value determination unit 44 determines to be similar to the acquired image out of the foregoing fingerprint images. For example, if the acquired image and the fingerprint image a are determined to be similar, the load data selection unit 52 reads the recording setting data corresponding to the fingerprint image a. The display unit 26 lists the program names of, for example, top four programs included in the read recording setting data in descending order of the number of times of recording, i.e., the programs A, B, C, and D in this order. When the recording setting data contains programs that have been recorded the same number of times, any of the programs may come first.

If the data holding unit 30 holds a plurality of fingerprint images that the similarity value determination unit 44 determines to be similar to the acquired image, the load data selection unit 52 synthesizes the pieces of recording setting data associated with the respective fingerprint images. The load data selection unit 52 thereby generates new recording setting data to read. For example, when the acquired image is similar to both the fingerprint image a and the finger print image b, the load data selection unit 52 synthesizes the pieces of recording setting data associated with the respective fingerprint images a and b to generate new recording setting data, and reads the same. In this way, the pieces of recording setting data that may correspond to the preferences of a user can be synthesized to read recording setting data more favorable to the user.

Now, an example of the technique for synthesizing recording setting data will be described. The load data selection unit 52 sums up the numbers of times of recording of each program included in the recording setting data, and generates new recording setting data by sorting the programs in descending order of the number of times of recording. Suppose, for example, that the recording setting data corresponding to the fingerprint image a shows that the program A has been recorded ten times, the program B eight times, the program C six times, and the program D four times, and the recording setting data corresponding to the fingerprint image b shows that the program B has been recorded ten times, the program C seven times, the program A five times, and the program E three times. When the numbers of times of recording of the programs included in both the pieces of recording setting data are summed up program by program, it follows that the program A has been recorded fifteen times, the program B eighteen times, the program C thirteen times, the program D four times, and the program E three times. That is, the newly-generated recording setting data will contain the programs B, A, C, D, and E in this order. The display unit 26 displays the top four programs B, A, C, and D in this order. Note that the foregoing description has dealt with the case of synthesizing a plurality of pieces of recording setting data. Nevertheless, when the data holding unit 30 holds a plurality of types of fingerprint images that are similar to the acquired image, the pieces of recording setting data corresponding to the plurality of types of respective fingerprint images may be read without synthesis. In this case, the display unit 26 displays all the program names included in the plurality of pieces of recording setting data read.

If the acquired image is not similar to any of the held images, the load data selection unit 52 reads certain recording setting data which is prepared in the data holding unit 30 in advance. For example, the data holding unit 30 holds in advance a piece of recording setting data which contains the program names of four programs that are typically likely to be recorded, as the certain recording setting data. If an acquired image is not similar to any of the held images, the load data selection unit 52 reads the recording setting data held in advance, and the display unit 26 displays the four programs included in the recording setting data. The numbers of times of recording of these four programs are all set to 0. It is understood that the user can also record programs other than the four displayed.

As has been described, according to the present embodiment, if the data holding unit 30 holds a fingerprint image(s) that is/are similar to an acquired image, the load data selection unit 52 reads the recording setting data corresponding to the fingerprint image(s). On the other hand, if the data holding unit 30 does not hold any fingerprint image that is similar to the acquired image, the load data selection unit 52 reads the recording setting data held in the data holding unit 30 in advance. As a result, even when the authentication unit 60 determines an identical user as being different individuals, some recording setting data can be read so that the user can access the hard disk recorder by using the recording setting data read.

The data on programs to be included in the recording setting data may be classified by the contents of the programs instead of the specific programs themselves. For example, when recording setting data includes such program classifications as sport programs, news programs, and educational programs, the display unit 26 refers to the classifications included in the read recording setting data and displays recommended programs pertaining to the classifications with highlights.

Now, description will be given of how to update the recording setting data. When recording setting data is read by the load data selection unit 52 and then the user records a program, the data update unit 54 updates the read data in accordance with the program recorded by the user. For example, suppose that the recording setting data included in the data set C is read and the recording setting data shows that the program D has been recorded ten times, the program E nine times, the program F seven times, and the program C five times. If the user records the program E, the data update unit 54 rewrites the data so that the number of times of recording of the program E is ten. If the user also records the program E on another occasion, the data update unit 54 rewrites the data so that the number of times of recording of the program E is eleven. Here, the number of times of recording of the program E exceeds that of the program D, or ten. The data update unit 54 thus switches the ranks of the programs D and E. That is, the recording setting data is updated to list the program names of the programs E, D, F, and C in this order. If the user does not record any program after the recording setting data is read by the load data selection unit 52, the data update unit 54 will not update the recording setting data. Incidentally, the user can configure settings so as to preclude the data update unit 54 from updating data, in cases where recording is performed by another person instead of the user himself/herself.

When a plurality of types of recording setting data are read by the load data selection unit 52 without synthesis and then the user records a program, the data update unit 54 updates each of the plurality of pieces of read recording setting data in accordance with the program recorded by the user. For example, in each of the plurality of pieces of read recording setting data, the number of times of recording of the user-recorded program is incremented by one. The resultant is then rewritten as new recording setting data.

Now, suppose that an acquired image is not similar to any of the held images, and certain recording setting data prepared in the data holding unit 30 in advance is thus read before the user records a program. In this case, the new entry unit 56 creates recording setting data in accordance with the recorded program, associates the acquired image and the recording setting data into a new data set, and stores it into the data holding unit 30. For example, when the certain recording setting data mentioned above is read and then the user records one of the four programs included in the recording setting data, the new entry unit 56 sets the number of times of recording of that program to one, associates the recording setting data with the fingerprint image of the user, and stores the resultant into the data holding unit 30 as a new data set.

Now, the processing steps of the data processing apparatus according to the present invention will be described.

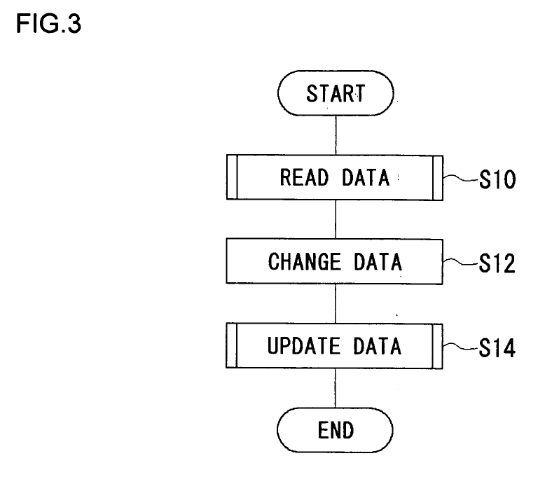

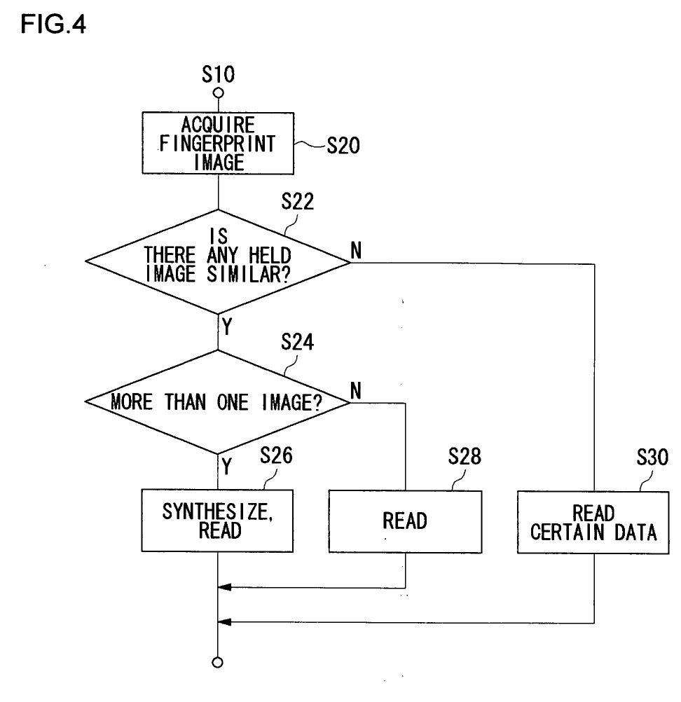

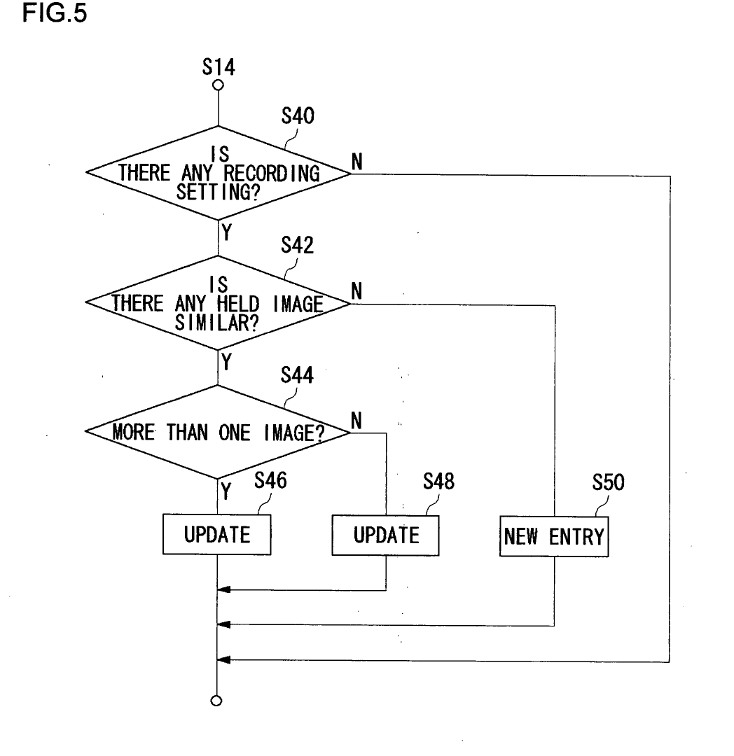

FIG. 3 is a flowchart for outlining the processing steps of the data processing apparatus according to the present invention. The load data selection unit 52 reads the recording setting data that is associated with a held image(s) similar to an acquired image (S10). The user records a program, i.e., makes a change to the recording setting data (S12). When the user records the program, the data update unit 54 updates the recording setting data (S14). The processing of S10 and S14 will be detailed in conjunction with FIGS. 4 and 5.

FIG. 4 is a flowchart for showing in detail the process of reading the recording setting data at S10 of FIG. 3. The fingerprint image acquisition unit 24 acquires the fingerprint image of the user during operation (S20). The similarity value determination unit 44 determines if the acquired image is similar to any of the held images (S22). If the acquired image is not similar to any of the held images (N at S22), the load data selection unit 52 reads certain recording setting data which is prepared in the data holding unit 30 in advance (S30). If only one of the held images is similar to the acquired image (Y at S22, N at S24), the load data selection unit 52 reads the recording setting data that is associated with that held image (S28). On the other hand, if there are a plurality of held images similar thereto (Y at S24), the load data selection unit 52 synthesizes the pieces of recording setting data associated with the plurality of respective held images and reads the resultant (S26).

When synthesizing the pieces of recording setting data, the load data selection unit 52 may assign weights depending on the similarity values thereof. For instance, description will now be given of an example where the acquired image is similar to both the fingerprint image a and the fingerprint image b shown in FIG. 2, and the load data selection unit 52 reads the pieces of recording setting data associated with the respective fingerprint images a and b. Here, the recording setting data corresponding to the fingerprint image a shows that the program A has been recorded ten times, the program B eight times, the program C six times, and the program D four times. The recording setting data corresponding to the fingerprint image b shows that the program B has been recorded ten times, the program C seven times, the program A five times, and the program E three times. Suppose also that a similarity value between the acquired image and the fingerprint image a is 10, and a similarity value between the acquired image and the fingerprint image b is 3. When synthesizing the recording setting data, the numbers of times of recording of the respective programs included in the recording setting data corresponding to the fingerprint image a are multiplied by the similarity value of 10. The numbers of times of recording of the respective programs included in the recording setting data corresponding to the fingerprint image b are multiplied by the similarity value of 3. In total, the number of times of recording of the program A is 115, the program B 110, the program C 81, the program D 40, and the program E 9. The load data selection unit 52 generates new recording setting data by sorting the programs A, B, C, D, and E in descending order of the number of times of recording, and reads the same. That is, the newly-generated recording setting data contains the program names of the programs A, B, C, D, and E in this order. The display unit 26 lists the program names of the top four programs A, B, C, and D in this order. Since the synthesis involves weighting in accordance with the similarity values, the pieces of recording setting data associated with fingerprint images of higher similarities to the acquired image can be synthesized so that the information on the user-recorded programs is better reflected.

FIG. 5 is a flowchart for showing in detail the process of updating the recording setting data at S14 of FIG. 3. If the user does not record any program after the recording setting data is read by the load data selection unit 52 (N at S40), the data update unit 54 will not update the recording setting data. On the other hand, if the user records a program (Y at S40) and there is no held image similar to the acquired image (N at S42), the new entry unit 56 creates recording setting data by setting the number of times of recording of the user-recorded program to one. The new entry unit 56 then associates the data with the acquired image, and stores it into the data holding unit 30 as a single data set (S50). If only one of the held images is similar to the acquired image (Y at S42, N at S44), the data update unit 54 updates the recording setting data (S48). On the other hand, if there are a plurality of held images that are similar to the acquired image (Y at S44), the data update unit 54 updates the pieces of recording setting data associated with the plurality of respective held images (S46).

When the data holding unit 30 holds a plurality of fingerprint images that are similar to the acquired image, and the pieces of recording setting data corresponding to the plurality of fingerprint images are read, the data update unit 54 may update the pieces of data while assigning weights corresponding to the similarity values. For instance, description will now be given of an example where the acquired image is similar to both the fingerprint image a and the fingerprint image b shown in FIG. 2, and the load data selection unit 52 reads the pieces of recording setting data associated with the respective fingerprint images a and b. Here, the recording setting data corresponding to the fingerprint image a shows that the program A has been recorded ten times, the program B eight times, the program C six times, and the program D four times. The recording setting data corresponding to the fingerprint image b shows that the program B has been recorded ten times, the program C seven times, the program A five times, and the program E three times. Suppose also that a similarity value between the acquired image and the fingerprint image a is 10, and a similarity value between the acquired image and the fingerprint image b is 3. When the user records the program A, the data update unit 54 adds ten to the number of times of recording of the program A included in the recording setting data that is associated with the fingerprint image a. The data update unit 54 also adds three to the number of times of recording of the program A included in the recording setting data that is associated with the fingerprint image b. As a result, the recording setting data corresponding to the fingerprint image a shows that the program A has been recorded twenty times, the program B eight times, the program C six times, and the program D four times. The recording setting data corresponding to the fingerprint image b shows that the program B has been recorded ten times, the program C seven times, the program A eight times, and the program E three times. Consequently, in the recording setting data associated with the fingerprint image b, the programs A and C change ranks so that the programs come in order of B, A, C, and E. Due to the weighting in accordance with the similarity values, the pieces of recording setting data associated with the fingerprint images of higher similarities to the acquired image can be updated so that the information on the user-recorded program is better reflected.

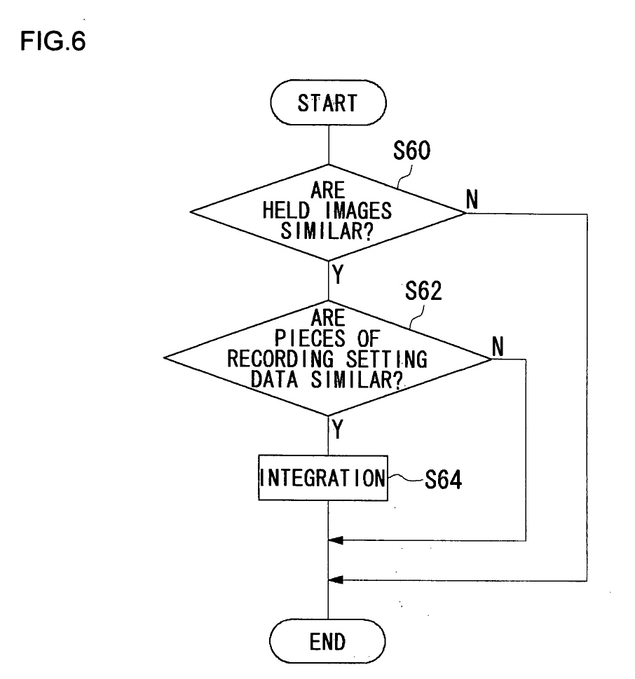

FIG. 6 is a flowchart for showing the process of integrating recording setting data. The similarity value determination unit 44 determines if the held images are similar to each other (S60). If there are no held images similar to each other (N at S60), the data integration unit 58 will not integrate any data sets. If there are held images similar to each other (Y at S60), the associated data similarity determination unit 46 determines whether or not the pieces of recording setting data corresponding to the respective similar held images are similar to each other (S62) If the pieces of recording setting data are not similar to each other (N at S62), the data integration unit 58 will not integrate the data sets. If the pieces of recording setting data are similar to each other (Y at S62), the data integration unit 58 integrates the data sets (S64).

Now, description will be given of how to determine whether pieces of recording setting data are similar or not. The associated data similarity determination unit 46 determines that pieces of recording setting data are similar if they contain overlapping programs as many as or more than a predetermined number. To take an example, description will be given of the recording setting data included in the data sets shown in FIG. 2. The predetermined number shall be three. The pieces of recording setting data included in the data sets 70 and 71 are compared with each other. The recording setting data of the data set 70 contains the programs A, B, C, and D. The recording setting data of the data set 71 contains the programs B, C, A, and E. Among the programs contained in the data sets 70 and 71, what are overlapping are the three programs A, B, and C. Since the number of overlapping programs reaches or exceeds the predetermined number, the pieces of recording setting data included in the respective data sets 70 and 71 are determined to be similar to each other. Meanwhile, the recording setting data of the data set 72 contains the programs D, E, F, and C. A comparison between the pieces of recording setting data included in the data sets 70 and 72 thus shows that the two programs C and D are overlapping. Since the number of overlapping programs falls below the predetermined number, the pieces of recording setting data included in the respective data sets 70 and 72 are determined not to be similar to each other.

According to the data processing apparatus of the present invention, when an identical user uses the hard disk recorder twice, for example, and the similarity value determination unit 44 determines that the fingerprint images in the respective times of use are not similar to each other, the user is authenticated as two different individuals. In such cases, the data holding unit 30 associates the fingerprint images at the respective times of use with the recording setting data corresponding to the contents of recording by the user at those times, and holds the resultant as separate data sets. As the user continues using the hard disk recorder, the pieces of recording setting data in the two data sets increase in the degree of similarity. If the data integration unit 58 integrates data sets on condition that the pieces of recording setting data are similar to each other, then the data integration unit 58 determines that the two data sets are of an identical user, and integrates them into a single data set. This can suppress a decrease of the free space in the data holding unit 30.

In the present embodiment, the similarity value determination unit 44 determines whether or not the held images are similar to each other and the pieces of recording setting data are similar to each other, at regular intervals irrespective of user operations. When similar images or data are found, the data integration units 58 integrates those held images and recording setting data into a data set. Since the data sets are thus integrated automatically, the user need not make any operation for integration. As employed herein, the “integration” refers to such cases that fingerprint images and pieces of recording setting data included in a plurality of respective data sets are synthesized into a single data set. Fingerprint images may be synthesized by using known image synthesis methods such as selection of a single fingerprint image and averaging of a plurality of fingerprint images.

In the present embodiment, the data integration unit 58 integrates data sets when the held images are similar to each other and the pieces of recording setting data are similar to each other. Instead, the data integration unit 58 may integrate data sets when either the held images or the pieces of recording setting data are similar to each other.

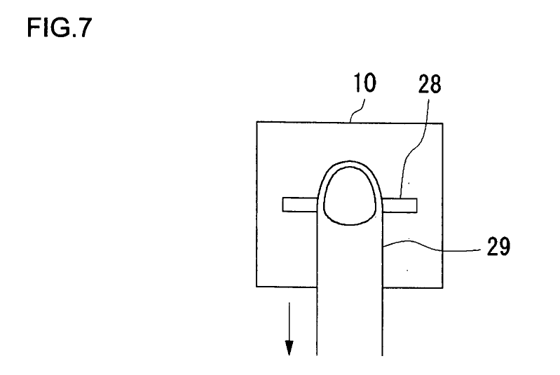

FIG. 7 is a diagram for explaining how to operate the hard disk recorder and how to acquire a fingerprint image. The data processing apparatus 10 has a line sensor 28 for accepting user operations and acquiring fingerprint images. As shown in the diagram, the line sensor 28 has the shape of an oblong rectangular. The user slides one of his/her fingers 29 over the line sensor 28 to operate the hard disk recorder and make the line sensor 28 acquire a fingerprint image. For example, the hard disk recorder can be powered on when the finger 29 is moved once downward in FIG. 7, i.e., in the lateral direction of the line sensor 28 as shown by the arrow. The hard disk recorder also plays when the finger 29 is moved once to the right, fast forwards when twice to the right, stops when once to the left, and rewinds when twice to the left. When the user moves the finger 29 in the lateral direction of the line sensor 28, a fingerprint image of the user is acquired. That is, the fingerprint image is acquired simultaneously with power-on. On the other hand, when the finger is moved to the right or left of the line sensor 28, no fingerprint image will be acquired. According to the present embodiment, the user need not be aware of the operation for acquiring a fingerprint image explicitly.

In the present embodiment, the motion in the lateral direction of the line sensor 28 is made to turn on the power supply. Nevertheless, what is operated is not limited to the power supply. Frequent user operations such as playback may be utilized to acquire a fingerprint image with the line sensor 28 simultaneously.

In the present embodiment, a single line sensor is used to make a plurality of operations on the hard disk recorder and acquire fingerprint images. This can reduce the installation area of the operation unit 22.

In the present embodiment, fingerprint images are acquired for the sake of user authentication. When the authentication unit 60 determines that an acquired image is a child's fingerprint image, the data processing unit 10 may limit recordable programs. This makes it possible to preclude children from recording and playing back age-limited programs.

In the present embodiment, the line sensor 28 has the oblong shape along the horizontal direction in FIG. 7. Nevertheless, the line sensor 28 may be configured smaller than the user's finger 29. In this case, the sensor can detect finger motions from a fingerprint pattern, a pressure distribution, or the like. This can reduce the installation area of the operation unit 22.

In the present embodiment, the authentication processing is performed when a finger motion in the lateral direction of the line sensor 28 is detected. Nevertheless, the authentication processing may be performed when a finger motion in the longitudinal direction of the line sensor 28 is detected.

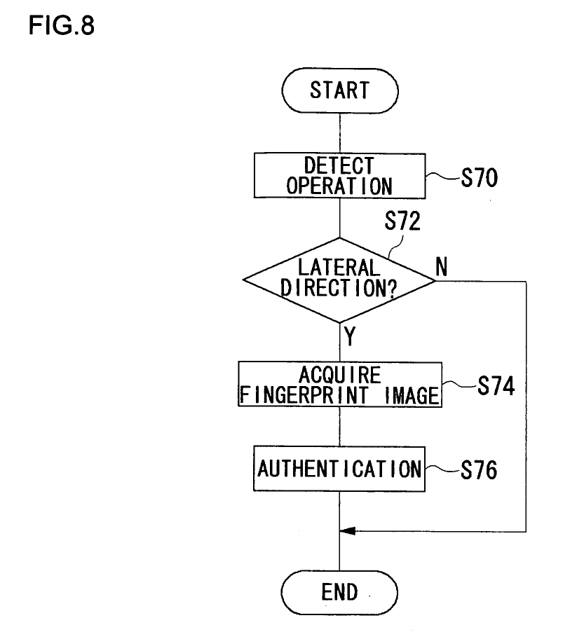

FIG. 8 is a flowchart for user authentication. The line sensor 28 detects an operation of the user's finger 29 which is moving over the line sensor 28 (S70) If the line sensor 28 detects a finger motion in the lateral direction of the line sensor 28 (Y at S72), the line sensor 28 acquires a fingerprint image of the user (S74). The authentication unit 60 performs user authentication processing by using the acquired fingerprint image (S76). On the other hand, if the line sensor 28 does not detect a finger motion in the lateral direction of the line sensor 28 (N at S72), the authentication unit 60 will not perform the user authentication processing.

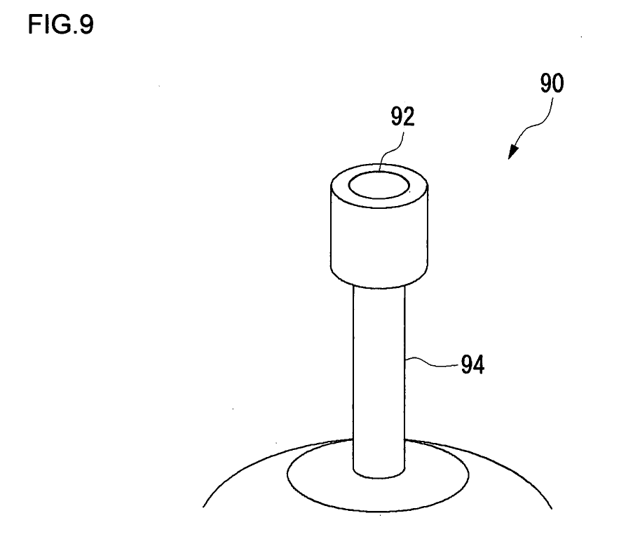

In the present embodiment, the operation unit 22 has the line, sensor 28. In a modified example, as shown in FIG. 9, the operation unit 22 may be formed as a so-called joystick 90. A sensor 92 for acquiring fingerprint images is arranged at the top of a stick portion 94 of the joystick 90. The user puts one of his/her fingers on the sensor 92 to power on the hard disk recorder. When powered on, the sensor 92 acquires a fingerprint image of the user, and the authentication unit 60 performs user authentication processing. The user can tilt the stick portion 94 of the joystick 90 in all directions to operate the hard disk recorder. For example, the stick portion 94 can be tilted once forward to play back, once to the right to fast forward, once to the left to rewind, and once backward to stop. According to this modification, when the joystick 90 is operated, a fingerprint image is acquired by the sensor which lies at the top of the stick portion 94 where a finger naturally comes into contact with. The user thus need not be aware of the operation of acquiring a fingerprint image explicitly.

In this modification, putting a finger on the sensor 92 turns on the power supply. Nevertheless, what is operated is not limited to the power supply. Frequent user operations such as playback may be utilized to acquire a fingerprint image with the sensor 92 simultaneously.

In another modification, the operation unit 22 may be a jog dial that has a sensor for acquiring fingerprint images.

The embodiment has dealt with the case where the personal authentication apparatus according to the present invention is applied to a hard disk recorder. In one of modifications conceivable from the present invention, for example, the personal authentication apparatus may be mounted on a game console. Suppose that the user of the game console is a child. When the user uses the game console, the fingerprint image acquisition unit 24 acquires a fingerprint image of the user. The authentication unit 60 authenticates the user as a child. A parent of the user can make a setting in advance, for example, so that the game console is automatically powered off when continuously operated beyond a certain period of time. This makes it possible to preclude the child from playing games too heavily. The line sensor having a small installation area as described above can be used to mount the personal authentication apparatus even on compact game consoles. It is therefore possible to suppress excessive game play on the compact game consoles.

In another modification, the personal authentication apparatus can be mounted on fire-banned devices so as to avoid use of the devices by children.

The embodiment has dealt with the case of acquiring fingerprint images. Modifications conceivable from the present invention are not limited to technologies for authenticating individuals by using fingerprints, but may also be applied to technologies using information on such images as palm prints, irises, veins, faces, retinas, and the like.

What is claimed is:

1. A data processing apparatus comprising:
a data holding unit which holds a data set composed of biometric data and associated data associated with the biometric data;
a biometric data acquisition unit which acquires biometric data newly from a user;
a similarity evaluation unit which compares the biometric data newly acquired from the user and the biometric data held in the data holding unit, and indicates a degree of similarity therebetween as a similarity value by using a similarity evaluation function for indicating a degree of similarity between a plurality of types of biometric data; and
a load data selection unit which reads associated data corresponding to biometric data having a similarity value reaching or exceeding a predetermined value if the biometric data having the similarity value reaching or exceeding the predetermined value is held in the data holding unit, and reading certain data prepared in advance if not.

2. The data processing apparatus according to claim 1, wherein when the data holding unit holds a plurality of types of biometric data each having a similarity value reaching or exceeding the predetermined value, the load data selection unit reads pieces of associated data corresponding to the plurality of respective types of biometric data.

3. The data processing apparatus according to claim 2, wherein when the data holding unit holds a plurality of types of biometric data each having a similarity value reaching or exceeding the predetermined value, the load data selection unit generates synthesized data by synthesizing the pieces of associated data corresponding to the plurality of respective types of biometric data, and reads the synthesized data.

4. The data processing apparatus according to claim 3, wherein when the data holding unit holds a plurality of types of biometric data each having a similarity value reaching or exceeding the predetermined value, the load data selection unit generates the synthesized data while assigning weights to the pieces of associated data corresponding to the plurality of types of biometric data in accordance with their respective similarity values.

5. The data processing apparatus according to claim 1, further comprising:
an operation unit which accepts a user input for changing contents of the read data; and
a data update unit which updates the read data in accordance with the changed contents.

6. The data processing apparatus according to claim 2, further comprising:
an operation unit which accepts a user input for changing contents of the read data; and
a data update unit which updates the read data in accordance with the changed contents.

7. The data processing apparatus according to claim 3, further comprising:
an operation unit which accepts a user input for changing contents of the read data; and
a data update unit which updates the read data in accordance with the changed contents.

8. The data processing apparatus according to claim 4, further comprising:
an operation unit which accepts a user input for changing contents of the read data; and
a data update unit which updates the read data in accordance with the changed contents.

9. The data processing apparatus according to claim 5, wherein when the data holding unit holds a plurality of types of biometric data each having a similarity value reaching or exceeding the predetermined value and the read data is changed, the data update unit updates the plurality of types of associated data read, in accordance with the changed contents.

10. The data processing apparatus according to claim 6, wherein when the data holding unit holds a plurality of types of biometric data each having a similarity value reaching or exceeding the predetermined value and the read data is changed, the data update unit updates the plurality of types of associated data read, in accordance with the changed contents.

11. The data processing apparatus according to claim 7, wherein when the data holding unit holds a plurality of types of biometric data each having a similarity value reaching or exceeding the predetermined value and the read data is changed, the data update unit updates the plurality of types of associated data read, in accordance with the changed contents.

12. The data processing apparatus according to claim 8, wherein when the data holding unit holds a plurality of types of biometric data each having a similarity value reaching or exceeding the predetermined value and the read data is changed, the data update unit updates the plurality of types of associated data read, in accordance with the changed contents.

13. The data processing apparatus according to claim 9, wherein when the data holding unit holds a plurality of types of biometric data each having a similarity value reaching or exceeding the predetermined value and the read data is changed, the data update unit updates the associated data read while assigning weights to the pieces of associated data in accordance with the respective similarity values.

14. The data processing apparatus according to claim 5, wherein when the data holding unit does not hold any piece of biometric data having the similarity value reaching or exceeding the predetermined value, the data update unit associates the certain data changed by the user and biometric data newly acquired from the user, and records the resultant into the data holding unit as a new data set.

15. The data processing apparatus according to claim 1, further comprising a data integration unit which integrates data sets pertaining to respective pieces of biometric data held in the data holding unit into a single data set when a similarity value calculated from between the pieces of biometric data reaches or exceeds a predetermined value.

16. The data processing apparatus according to claim 1, further comprising:
an associated data similarity determination unit which determines whether or not pieces of associated data held in the data holding unit are similar to each other based on a similarity determination condition for determining if pieces of associated data are similar to each other; and
a data integration unit which integrates data sets pertaining to respective pieces of associated data determined to be similar to each other into a single data set.

17. A personal authentication apparatus comprising:
an operating unit which accepts an operation made by a user;
a detection unit which detects the accepted operation;
a biometric data acquisition unit which acquires biometric data from a sensor arranged on the operation unit during operation; and
an authentication unit which performs personal authentication processing based on the biometric data acquired, and wherein
the authentication unit performs the personal authentication processing on condition that the detection unit detects a predetermined operation out of a plurality of types of operations.

18. The personal authentication apparatus according to claim 17, wherein the operation unit is a control lever.

19. A personal authentication apparatus comprising:
a detection unit which detects a plurality of types of operations in accordance with a finger motion of a user on an operation area;
a fingerprint image acquisition unit which acquires a fingerprint image as biometric data from a sensor arranged in the operation area, on condition that the finger motion of the user on the operation area makes a predetermined movement; and
an authentication unit which performs personal authentication processing based on the fingerprint image acquired.

20. The personal authentication apparatus according to claim 19, wherein:
the detection unit detects the operations of the user via an operation area of line shape; and
the fingerprint image acquisition unit acquires the fingerprint image on condition that the user's finger moves in a lateral direction of the operation area.
